(19) United States
(12) Patent Application Publication
(10) Pub. No.: US 2017/0284051 A1
(43) Pub. Date: Oct. 5, 2017

(54) Soil Reinforcement Membrane and Related Systems and Methods

(71) Applicants: Konstantin Dragan, Moscow (RU); Mikhail Senik, Moscow (RU)

(72) Inventors: Konstantin Dragan, Moscow (RU); Mikhail Senik, Moscow (RU)

(21) Appl. No.: 15/346,002

(22) Filed: Nov. 8, 2016

Related U.S. Application Data
(60) Provisional application No. 62/318,719, filed on Apr. 5, 2016.

(51) Int. Cl. E02D 17/20; D04H 18/02; E02B 3/12; E02D 3/00; A01C 1/04; A01G 1/00

(52) U.S. Cl. CPC E02D 17/202; A01C 1/044; A01G 1/005; E02B 3/126; E02D 3/00; D04H 18/02

(57) ABSTRACT

A soil reinforcement membrane that promotes grass, plant, and vegetation growth in a variety of temperatures and geographic locations and increases water retention. The soil reinforcement membrane is flexible enough to be placed on a variety of landscapes and promotes growth in a variety of soils. The soil reinforcement membrane consists of an upper layer and a lower layer with a cultivating compound dispersed uniformly between the two layers.

### CROSS-REFERENCE TO RELATED APPLICATIONS

This application claims the benefit and priority of U.S. Provisional Pat. App. Ser. No. 62/318,719, filed Apr. 5, 2016, entitled “Non-Water Plant Growing System,” which is incorporated herein by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND AN INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of material for reinforcement of soil surfaces.

### Background of the Invention

This invention relates to the reinforcement and development of soils, grasses, plants, and other vegetation. There are many different soils, climates, and geometric landscapes that make it very difficult to develop and grow grass or other plants and vegetation. Accordingly, landscapers try to apply seeds, fertilizers, or other technologies to promote vegetation growth. Traditionally, fertilizer is sprayed or applied to the surface of a landscape, but this approach leaves the fertilizer susceptible to be washed away and there is nothing to retain excess water. Moreover, many products used to promote vegetation growth have poor water retention or pliability. Additionally, some products are harmful to the environment and even toxic to humans.

Furthermore, in certain climates, there water is a scarce resource, so there is a need for a membrane that retains water and gives the soil the nutrients it needs for optimal growth of vegetation. Thus, this soil reinforcement membrane solves the problems of water retention and getting the correct nutrients to specific soils based on climate and geographic location.

### SUMMARY OF THE INVENTION

In view of the foregoing, an object of this specification is to disclose a material designed for reinforcement of soil surface and topsoil.

It is another object of this invention to disclose a material to improve the development of grass lawns and landscaping.

It is another object of this invention to provide a material that is comprised of synthetic fibers that contain seeds and other nutrients and supplements for soil.

It is another object of this invention to provide a material that improves water conservation.

It is another object of this invention to provide a soil reinforcement material that is designed to adapt to numerous climates and conditions.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is a perspective view of the soil reinforcement membrane with the upper layer peeled back;

FIG. 2 is a perspective view of the soil reinforcement membrane;

FIG. 3 is an environmental view of the cross-section of the soil and soil reinforcement membrane; and,

FIG. 4 is an environmental view of the cross-section of the soil and soil reinforcement membrane.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed is a soil reinforcement membrane.

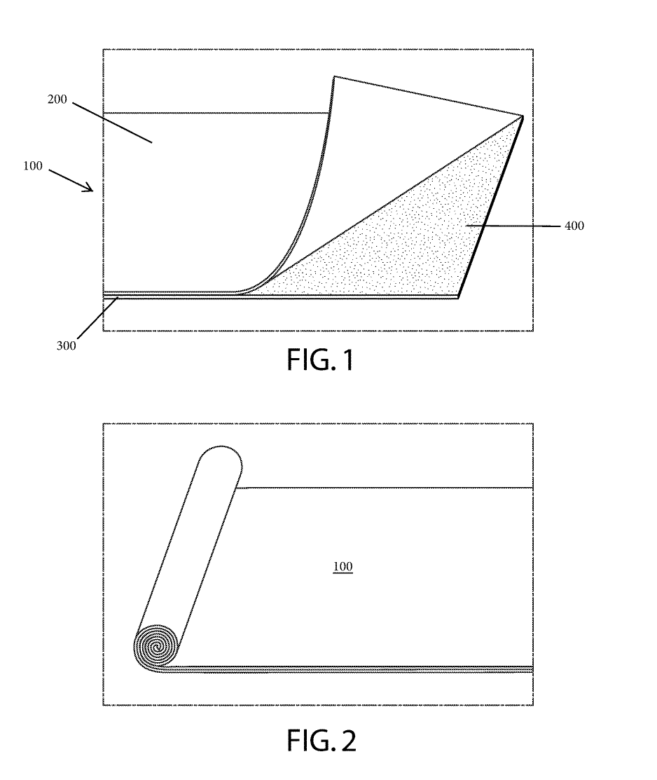

FIG. 1 is a perspective view of the soil reinforcement membrane 100 with the upper layer 200 peeled back. In one embodiment, the upper layer 200 and lower layer 300 are made of synthetic fibers. In a preferred embodiment, the upper and lower layers 200,300 may be composed of 100% polyether or polyester fiber and they may have surface densities that range from 680 to 870 grams per square meter (“gsm”). Referring to FIG. 1, there is a layer of cultivating compounds 400 dispersed onto the lower layer 300. The cultivating compounds 400 dispersed onto the lower layer 300 may be seeds of perennial grasses, mineral fertilizers, biological fertilizers, slow release growth stimulators, moisture retaining components, and any other compound that may be used for vegetation. FIG. 2 is a perspective view of the soil reinforcement membrane 100 unrolled before application to a soil. The cultivating compounds 400 are specifically and selectively designed for different climates and soil conditions.

Referring to FIG. 1, the cultivating compounds 400 allow the soil reinforcement membrane 100 to be designed for biological recultivation of disturbed lands, sloped hills by roads and rail ways, embankments, ground surfaces of quarries and mines, and oil and gas pipeline routes. The soil reinforcement membrane 100 also protects slopes from erosion and gullying. The soil reinforcement membrane 100 may even be applied in boreal climates and promote cultivation of vegetation.

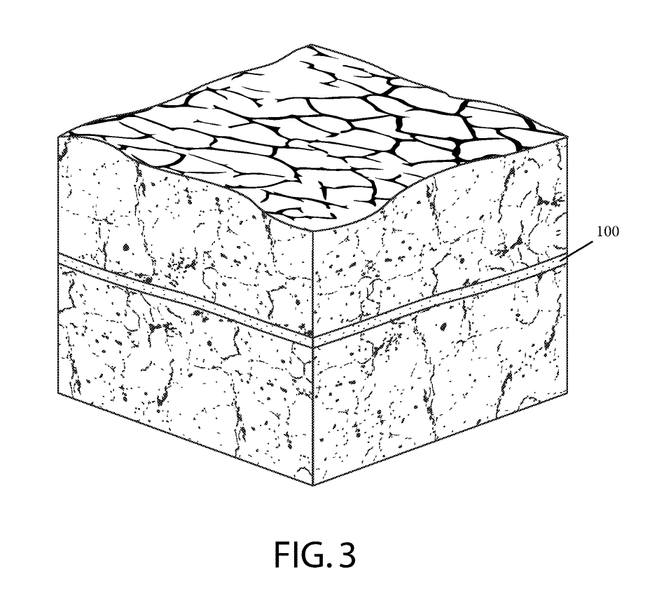

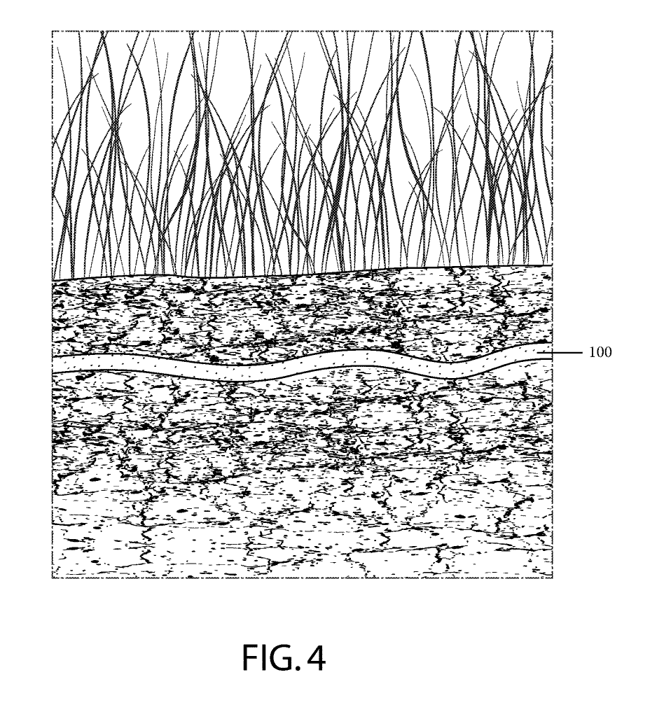

FIG. 3 is a cross sectional contextual view of the soil reinforcement membrane 100 applied between two layers of soil. FIG. 4 is a cross sectional contextual view of the soil reinforcement membrane applied between two layers of soil and promoting the growth of vegetation. In use, the soil reinforcement membrane 100 and cultivating compounds 400 will form uniform grass with a heavy root system, wherein the root system penetrates deep into the soil, binds subsoil, and creates sod, which produces high mechanical stability.

In one embodiment, the soil reinforcement membrane 100 is applied in dry weather conditions and when there is a positive air temperature on the pre-planned and smoothed out soil surface (i.e., sand, clay, loam, sand clay, silts). Soil chunks should be no more than 50 millimeters in size.

The soil reinforcement membrane 100 reduces the amount of water necessary to water the soil because the soil reinforcement membrane 100 traps water within it and conserves the water for use over time.

In one embodiment, the soil reinforcement membrane 100 may be manufactured on needle-punching machines. Referring to the manufacturing process, two rolls of geotextile material (i.e., polypropylene, polyvinyl chloride, polyester, or polyether) of different densities comprise the upper and lower layers/textiles 200,300. In a preferred embodiment, the geotextile material is either polypropylene or polyvinyl chloride, but the upper and lower textile 200,300 will be of the same material. In one embodiment, the lower textile 300, which may be used as the base, has a greater density than the upper textile 200. In a preferred embodiment, the lower textile 300 has a density of 250-300 grams per meter squared (g/m²), but preferably 300 g/m² and the upper textile 200 has a density of 100-150 g/m², but preferably 150 g/m². In a preferred embodiment, the upper layer 200 is less dense than the lower layer 300 in order to allow the vegetation to sprout to the surface. The lower layer 300 is preferably more dense in order to provide protection from potential obstacles (i.e., rocks and sharp objects). Also, a root system is more powerful, so it can more easily travel through the more dense lower layer 300.

To manufacture the soil reinforcement membrane 100, a mixture of cultivating compounds 400 (i.e., seeds, fertilizer, and water accumulator) are dispensed onto the lower textile 300 that is on a vibrating table, which allows the mixture of cultivating compounds 400 to be distributed uniformly. In a preferred embodiment, 60 grams of seeds of permanent grasses, 30 grams of perlite powder, and 15 grams of combined fertilizers are distributed for each square meter. All of these cultivating compounds 400 are uniformly sprayed onto the lower textile 300 from different dispensers. Once the lower textile 300 is covered with the cultivating compounds 400 and nutrients, the upper textile 200 is placed over the lower textile 300, fixed by two rollers, and placed onto a needle-punching table. Once on the needle-punching table, the upper textile 200 is sewn to the lower textile 300, wherein the needled plates punch the upper and lower textiles 200,300, preferably with a frequency of two punches per second. In one embodiment, the needled plate has 2,500 needles per meter squared (m²). The needle- punched textiles gives the soil reinforcement membrane 100 more flexibility and maneuverability. Accordingly, in a preferred embodiment, the synthetic fibers and needle-punched design allows the soil reinforcement membrane 100 to be manipulated in a manner that allows it to be applied to and conform to uneven slopes and a variety of other landscapes.

In one embodiment, the rolls of soil reinforcement membrane 100 can be installed on “prepared” soil, that is with the upper layer of the soil removed, or “unprepared” soil, wherein herbage will be formed at a later time, but the end results will be the same whether installed on “prepared” or “unprepared” soil. After the soil reinforcement membrane 100 is placed onto the ground, in one embodiment, the soil reinforcement membrane 100 will be covered with a layer of 10-15 centimeters of soil. Then, in one embodiment, the soil reinforcement membrane 100 is irrigated with five liters of water per meter squared every day for three days. After this initial irrigation period, the soil reinforcement membrane 100 no longer needs to be irrigated. In a preferred embodiment, after approximately six to seven days, grass will sprout to the surface and after 2-3 weeks, thick herbage and a root system is formed.

In one embodiment, jute or a nonwoven propylene mesh may be inserted between the upper and lower layer 200,300 to increase the strength of the soil reinforcement membrane 100. In another embodiment, the geotextile membrane may be biodegradable.

In a preferred embodiment, the upper and lower layers 200,300 will not have ruptures, cracks, or holes.

In a preferred embodiment, the soil reinforcement membrane 100 is manufactured of low toxic components that do not adversely affect the human body during contact with a skin's surface.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

1. A soil reinforcement membrane comprised of:
an upper layer composed of a geotextile material;
a lower layer composed of a geotextile material;
a cultivating compound that is dispersed over a surface of the lower layer and provided between the upper layer and the lower layer, wherein the upper layer is needle punched to the lower layer; and,
an insert between the upper and lower layer whereby the strength of the soil reinforcement membrane is increased, wherein the insert is selected from the group consisting essentially of jute and nonwoven propylene mesh.

2. The soil reinforcement membrane of claim 1, wherein the lower layer has a density in the range of 250-300 grams per meter squared.

3. The soil reinforcement membrane of claim 2, wherein the lower layer has a higher density than the upper layer.

4. The soil reinforcement membrane of claim 3, wherein the upper layer has a density in the range of 100-150 grams per meter squared.

5. The soil reinforcement membrane of claim 4, wherein the cultivating compound is about 60 grams of seeds of permanent grasses per square meter, about 30 grams of perlite powder per square meter, and about 15 grams of combined fertilizers per square meter.

6. The soil reinforcement membrane of claim 5, wherein the geotextile is polypropylene.

7. The soil reinforcement membrane of claim 5 wherein the geotextile is polyvinyl chloride.

8. A method of promoting vegetation growing comprising:
obtaining a soil reinforcement membrane comprised of an upper and lower layer composed of a geotextile material, a cultivating compound that is dispersed over a surface of the lower layer and provided between the upper and lower layers, and an insert between the upper and lower layers for increasing the strength of the soil reinforcement membrane;
wherein said insert is selected from the group consisting of jute or nonwoven propylene mesh;
placing the soil reinforcement membrane onto a landscape, wherein the landscape is defined by a pre-planned area with positive air temperature and a smoothed out soil surface that has soil chunks that are fifty millimeters in size or smaller;
covering the soil reinforcement membrane with a layer of soil; and,
irrigating the soil reinforcement membrane, soil, and landscape everyday for three days with five liters of water per meter squared per day.

9. The method of claim 8, wherein the layer of soil is in a range of 10-15 centimeters.

10. The method of claim 9, wherein the lower layer has a greater density than the upper layer.

11. The method of claim 10, wherein the upper and lower layer are needle punched together.

12. The method of claim 11, wherein the cultivating compound is about 60 grams of seeds of permanent grasses per square meter, about 30 grams of perlite powder per square meter, and about 15 grams of combined fertilizers per square meter.

13. A method of manufacturing a soil reinforcement membrane comprising:
obtaining two rolls of a geotextile material, cultivating compounds, and a needle punching machine, wherein a first one of the rolls forms a lower layer when unrolled and the other roll forms the upper layer when unrolled;
unrolling the first one of the rolls onto a vibrating table so that the lower layer is positioned on the vibrating table;
dispensing the cultivating compounds onto the lower layer;
distributing the cultivating compounds via vibrations of the vibrating table;
unrolling the other roll to form the upper layer;
placing the upper layer over the lower layer;
inserting jute or a nonwoven propylene mesh between the upper and lower layers;
fixing the upper and lower layers by two rollers
placing the upper and lower layer onto a needle punching machine with a needle plate that has two-thousand and five hundred needles per meter squared; and,
sewing the upper and lower layer together via the needle punching machine.

14. The method of claim 13, wherein the lower layer has a density in the range of 250-300 grams per meter squared.

15. The method of claim 14, wherein the upper layer has a density in the range of 100-150 grams per meter squared.

16. The method of claim 15, wherein the cultivating compound is about 60 grams of seeds of permanent grasses per square meter, about 30 grams of perlite powder per square meter, and about 15 grams of combined fertilizers per square meter.

17. The method of claim 16, wherein the cultivating compound is distributed for each square meter.

18. The method of claim 17, wherein the needle punching machine sews at a frequency of two punches per second.

19. The method of claim 18, wherein the geotextile is polypropylene.

20. The method of claim 19, wherein the geotextile is polyvinyl chloride.
